(19) United States
(12) Patent Application Publication
(10) Pub. No.: US 2015/0054867 A1
(43) Pub. Date: Feb. 26, 2015

(54) PRINT NOZZLE AMPLIFIER WITH CAPACITIVE FEEDBACK

(71) Applicant: HEWLETT-PACKARD DEVELOPMENT COMPANY, L.P., HOUSTON, TX (US)

(72) Inventor: Andrew Van Brocklin, Corvallis, OR (US)

(21) Appl. No.: 14/374,781

(22) PCT Filed: Apr. 25, 2012
(86) PCT No.: PCT/US2012/034946

§ 371 Date: Jul. 25, 2014

(51) Int. Cl. B41J 2/045

(52) U.S. Cl. CPC B41J 2/04541
USPC 347/9

(57) ABSTRACT

An apparatus includes an operational amplifier to drive a print nozzle. A continuous time capacitive network can be employed as feedback by the operational amplifier. A reset control can be provided to adjust startup voltages in the continuous time capacitive network.

### RELATED APPLICATIONS

The present invention is a U.S. National Stage under 35 USC 371 patent application, claiming priority to Serial No. PCT/US2012/034946, filed on 25 Apr. 2012, the entirety of which is incorporated herein by reference.

### BACKGROUND

Print heads employ nozzles to dispense ink when commanded by electronic circuits such as operational amplifiers. One style of print head is a piezo head where voltages applied by the amplifiers to the piezo element of the print head cause ink to dispense from the head and associated nozzle. Current commercial piezo heads have drivers that use a cold switch circuit where there is a high power, high voltage operational amplifier that is located separately from the print head area, and connected typically by a single wire to the print head. This wire carries the waveform that all ink dispensing nozzles utilize. Existing piezo amplifier feedback schemes for cold switch circuits employ resistive elements for feedback. The resistive elements provide adequate gain control, have acceptable bandwidth, but have 10 mW to 100 mW power dissipation per resistive network. This amount of power dissipation is acceptable for one amplifier (with one feedback network) feeding one thousand nozzles, for example, but may be a prohibitive amount of power for other systems.

### BRIEF DESCRIPTION OF THE DRAWINGS

FIG. 1 illustrates an example apparatus that utilizes a continuous time capacitive network for feedback in an operational amplifier that drives a print nozzle.

FIG. 2 illustrates an example apparatus that utilizes a continuous time capacitive network for feedback in an operational amplifier that drives a print nozzle, wherein the capacitive network utilizes reset and gain controls.

FIG. 3 illustrates an example operational amplifier that employs a capacitive network as feedback to drive a piezo print nozzle.

FIG. 4 illustrates a waveform diagram for driving a capacitive feedback network of a print nozzle amplifier.

FIG. 5 illustrates an example method for generating the print nozzle drive waveforms depicted in FIG. 4.

FIG. 6 illustrates an example printer that employs amplifiers utilizing capacitive feedback, reset controls, and gain controls to drive a plurality of print nozzles.

### DETAILED DESCRIPTION

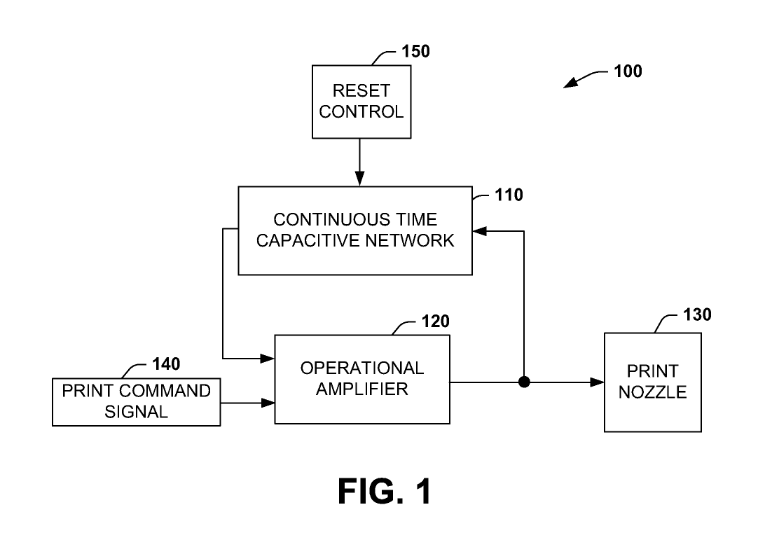

FIG. 1 illustrates an example apparatus 100 that utilizes a continuous time capacitive network 110 for feedback in an operational amplifier 120 that drives a print nozzle 130. As used herein, the term “continuous time” refers to a capacitive network that employs discrete capacitor components that can react to signals in a continuous manner over a frequency spectrum. This is in contrast to switched capacitor networks that operate in discrete time and according to a clock frequency that defines the equivalent impedance available. As shown, a print command signal 140 (e.g., voltage signal that commands ink to be dispensed from the print nozzle) is applied to an input of the operational amplifier 120 that amplifies the signal and applies it to the print nozzle 130. Amplification in the operational amplifier 120 is based on the ratio of impedance values of capacitors in the capacitive network 110 as opposed to the ratio of resistive feedback elements as in conventional drive circuits.

A reset control 150 is provided to adjust operations of the continuous time capacitive network 110 (also referred to as capacitive network 110). For example, during startup operations of the capacitive network 110, there may be residual voltages on discrete capacitors inside the capacitive network that require adjustment by the reset control 150 to some known voltage state. Such voltages in the capacitive network 110 can be reset by switching elements (e.g., FET's or other types of transistors) applied to the individual capacitors in the capacitive network. By utilizing capacitive feedback via the capacitive network 110 and in place of traditional resistive feedback, power dissipation in the operational amplifier 120 can be mitigated since there are no resistive leakage paths in the capacitive network 110. The reduced power savings is further enhanced since there can be hundreds of print nozzles 130—each requiring their own operational amplifier and capacitive network 110 to command ink dispersal from the respective print nozzles. Although the operational amplifier 120, capacitive network 110, and reset control is shown separate from the print nozzle, such components could be integrated on a common platform as the print nozzle 130 such as in a print head assembly.

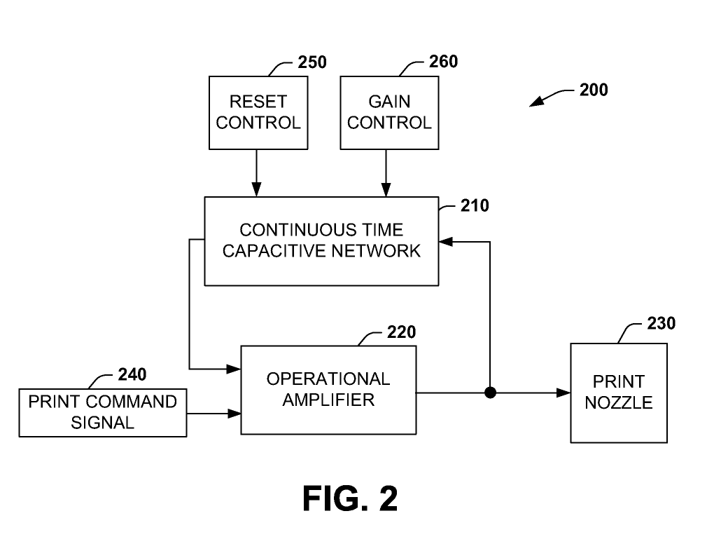

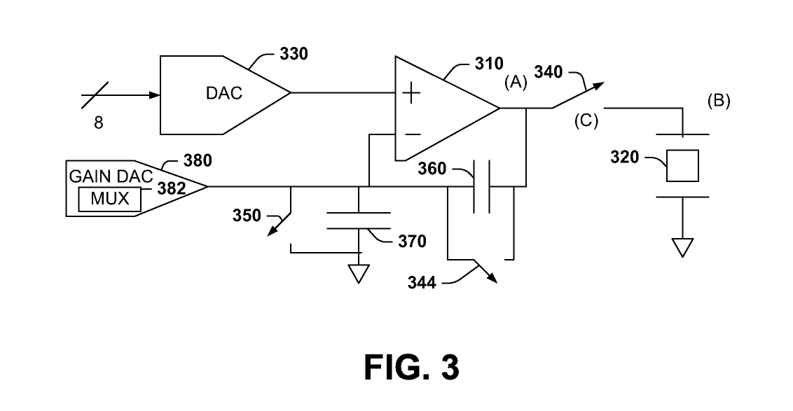

In one example, the apparatus 100 supports a feedback system via capacitive network 110 for a nozzle level operational amplifier 120 of a piezo print head that helps meet demanding requirements of low die area usage, high voltage operation, high slew rate, and low bias power dissipation. In general, piezo print heads utilize a method to amplify a desired waveform per print nozzle 130 while maintaining lower power dissipation. This feedback system utilizes the continuous time capacitive network 110 for feedback and for per-nozzle amplifier gain. Capacitive feedback elements versus resistive elements in conventional designs can use orders of magnitude less power and can be much reduced in circuit area. A single switch event can be employed by the reset control 150 to reset the feedback provided by the capacitive network 110, to conserve area needed by circuit elements of the operational amplifier 120, and conserve power through simplified high voltage switching. Since a single switch event is used per pixel print cycle, versus tens or hundreds of switching events for switched capacitor systems, the per-switching event power is reduced to a minimal amount. Continuous time operation of the capacitive network 110 also enables higher bandwidth operation due to the high bandwidth of the capacitive feedback network. A method of gain adjustment for process variation in the operational amplifier 120 is also described and illustrated below with respect to FIGS. 2 and 3.

For purposes of simplification of explanation, in the present example, different components of the systems described herein are illustrated and described as performing different functions. However, one of ordinary skill in the art will understand and appreciate that the functions of the described components can be performed by different components, and the functionality of several components can be combined and executed on a single component or be further distributed across more components. The components can be implemented, for example, as an integrated circuit or as discrete components, or as a combination of both. In other examples, the components could be distributed among different printed circuit boards, for example.

FIG. 2 illustrates an example apparatus 200 that utilizes a continuous time capacitive network 210 for feedback in an operational amplifier 220 that drives a print nozzle 230, wherein the capacitive network utilizes reset and gain controls. Similar to FIG. 1 above, a print command signal 240 can be applied to an input of the operational amplifier 220 that amplifies the signal and applies it to the print nozzle 230. Amplification in the operational amplifier 220 is based on impedance values of capacitors in the capacitive network 210 as opposed to resistive feedback elements in conventional drive circuits. A reset control 250 is provided to adjust operations of the continuous time capacitive network 210 (also referred to as capacitive network 210). For example, during startup operations of the capacitive network 210, there may be residual voltages on discrete capacitors inside the capacitive network that require adjustment by the reset control 250 to some known voltage state. In addition to the reset control 250, a gain control 260 may also be applied to the capacitive network 210. For example, a digital to analog converter (DAC) may apply a voltage inside the capacitive network 210 (e.g., to control a multiplexer that selects capacitors) to adjust gain parameters of the operational amplifier 220. Such gain adjustments can be utilized as compensation for process variation of the capacitive network 210 and/or operational amplifier 220.

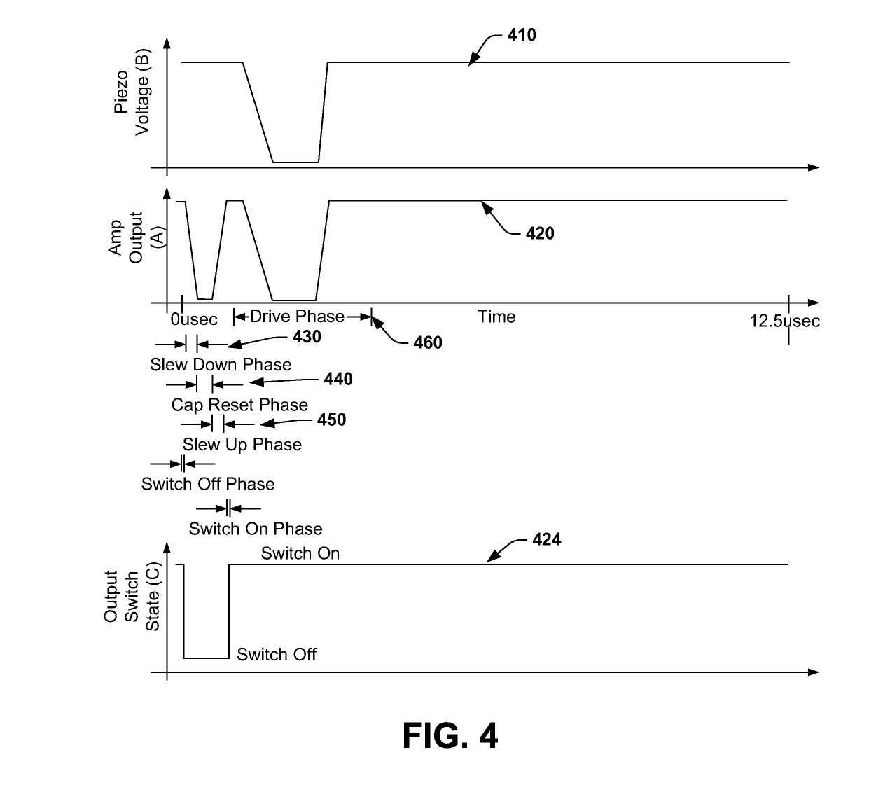

FIG. 3 illustrates an example operational amplifier 310 that employs a capacitive network as feedback to drive a piezo print nozzle 320. The piezo print nozzle 320 can include a micro-electromechanical system (MEMS) device that can be actuated by the operational amplifier 310. An eight bit signal DAC 330 is employed to send a print command signal to the operational amplifier 310 which in turn amplifies the signal to drive the piezo print nozzle 320. Although an eight-bit DAC 330 is shown, other bit resolutions are possible (e.g., 12 bit DAC, 6 bit DAC, and so forth). Various switching components (e.g., FET, transistor) are shown at 340, 344, and 350, wherein such switching components form the reset control described above. Switching component 340 disconnects the output from the operational amplifier 310 from the piezo print nozzle 320 during reset operations of the capacitive network. Capacitors 360 and 370 form the capacitive network described above and can be reset via switching components 344 and 350, respectively. As shown, a node (A) represents the output of the operational amplifier 310 and a node (B) represents the input to the piezo print nozzle 320. Print nozzle driving waveforms for Nodes (A) and (B) will be illustrated below with respect to FIG. 4.

A gain DAC 380 (e.g., 4 bit DAC), can be employed to apply additional capacitance to a leg of the feedback network to adjust the gain of the operational amplifier 310 plus feedback network input . The capacitance can be added via multiplexor 382 and can be employed to compensate for process variations in the capacitive network and/or operational amplifier itself. The DAC 380 in the feedback network allows significant process variation on the capacitive feedback network to be compensated for without losing amplifier performance due to excess gain. This large process variability may be driven from the use of High Voltage (MOM or Metal-Insulator-Metal) for capacitor 360 and Low Voltage PIP (Poly-Insulator-Poly) capacitor for capacitor 370 in the network. The MOM capacitor can be utilized because one side of this capacitor is high voltage, and this type of capacitor can withstand 100V in the print driving process described herein. However, it is quite large for a given capacitance. The PIP capacitor can typically withstand 12V maximum, but has almost ten times the area density per capacitance, so this type of capacitor is used for the low voltage side, between the negative input of the operational amplifier 310 and the virtual ground reference of the system, for example.

The MOM Cap can withstand 100V, so it can be used for the portion of the feedback network between the negative input and the high voltage output. The PIP cap and the MOM cap can be built in different stages of fabricating the circuits described herein, and as such, their variation in capacitance values may not track in a ratio, e.g., they have unrelated random distributions. Because of this, there may be a large gain range that needs adjusting. To adjust this network's gain, capacitance can be adjusted. It is lower cost in circuit area to adjust the PIP capacitor, since it is both lower in voltage and approximately ten times more dense in capacitance per unit area. The capacitive gain adjusting DAC 380 can add up to 25% to the value of the PIP capacitor by using multiplexers 382 to add in capacitors. It can be a 4 bit DAC, for example, and thus there would be four multiplexers that add or remove four binary weighted capacitances. Other DAC resolutions and multiplexer selections are also possible. The PIP capacitor (low voltage) can be shorted by a small in-area N and P MOS pair of switches for switch 350. The MOM capacitor (High Voltage) can be shorted by an N-LDMOS for switch 344, although minimum in size for such a device can be larger. The process of returning the output of the operational amplifier 310 to ground allows the use of the capacitor reset switches 344 and 350 without the use of power consuming high voltage level shifters. The charge (DC value) on the capacitors 360 and 370 can then be removed via the reset control switches 344 and 350 on each subsequent cycle.

In this example the operational amplifier 310 can be defined in open loop configuration as having a single dominant pole. That allows for a feedback network to define the gain, and thereby tradeoff gain for bandwidth. An additional use for feedback networks is set a controlled gain since the open loop gain of an amplifier is generally not adequately controlled due to process manufacturing variation.

Capacitors 360 and 370 form a capacitive divider as a feedback for the gain of the operational amplifier 310, wherein the gain can be defined as the ratio of any two impedances. If the impedances have different frequency responses, then the amplifier formed using this feedback structure can have a frequency response altered by this characteristic, as well as defining the gain.

In contrast to this example, using resistances as feedback elements requires that there is a DC current flow through the resistance, since the output voltage of up to 40V onto the piezo print nozzle is higher than the 1.5-3V voltage at the operational amplifier 310 input. If a large resistance of 100K ohms was chosen for feedback from the output of the operational amplifier 310 to the input, for example, this would yield 372/100k=14 mW power dissipation in this element. By employing capacitive feedback instead of resistance, 0.2 mW or less power dissipation in the feedback structure can be provided which is significantly less than conventional resistive feedback would provide.

The capacitive elements 360 and 370 are variable with frequency. However, it is desirable to have feedback that is substantially frequency independent, over the amplifier frequency range of interest, which is defined by the period and the frequency response; e.g., minimum of fmin=1/30 us=33 KHz and a maximum of fmax ˜=M*K/Tr, where Tr is the 200 ns rise time, M=4 is the settling factor and K is the proportionality for one time constant, fmax ˜=4*0.35/200 n=7 MHz. The gain response frequency through this bandwidth of the capacitive feedback elements 360 and 370 is T(ω)=(1/(Cl*ω))/(1/(Ch*ω)+1/(Cl*ω)), where CI is for capacitor 370, Ch is for capacitor 360, and w is the frequency. The w drops out of the equation as long as the frequency is kept above 0 and series resistive elements are small enough to be neglected. The resulting transfer function can be represented as T=(1/(Cl))/(1/(Ch)+1/(Cl)), which is substantially frequency independent, as desired. In order to actually provide the lowest frequency bandwidth at 33 KHz, for example, the capacitors 360 and 370 should be reset to provide some direct current (DC) value stabilization. Otherwise, the ω in the denominator of the T(ω) transfer function may cause undesirable drift in the driving waveform. In general, an undesirable charge can build up in the capacitors 360 and 370 over time if they are not reset. FIG. 4 depicts waveforms for driving and resetting capacitors 360 and 370.

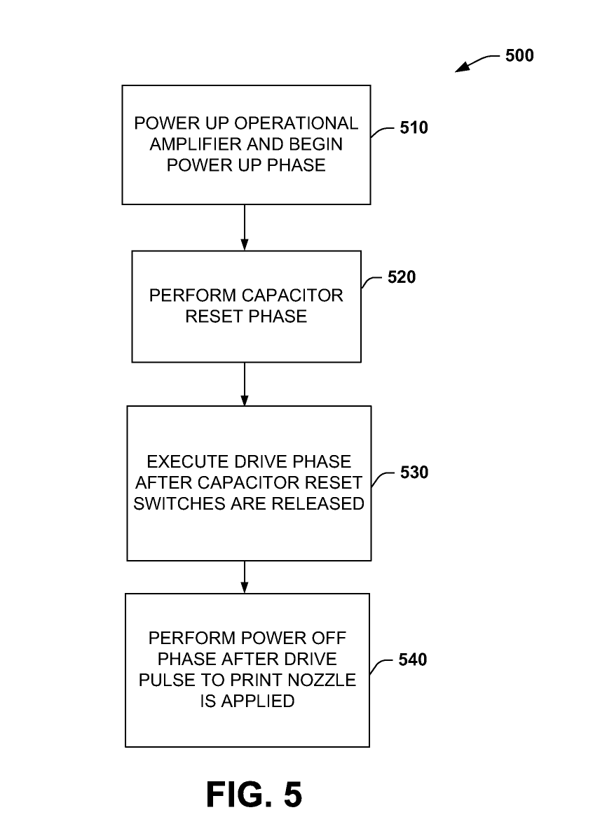

FIG. 4 illustrates a waveform diagram for driving the capacitive feedback network of a print nozzle amplifier. An example voltage waveform 410 that is applied to a print nozzle is shown and represents Node (B) illustrated in FIG. 3. An example waveform 420 represents an operational amplifier output and Node (A) illustrated in FIG. 3. A first phase for the waveforms 410 and 420 is prior to disconnecting a switch (C) which is element 340 in FIG. 3 shown at waveform 424. Then, switch (C) disconnects, and then the amplifier output (A) at 420 slews downward between timing lines 430, independent of the constant voltage on the MEMS piezo, which is disconnected as shown on waveform 410. When the amplifier voltage is low enough (e.g., below 3.3V) the next phase for waveforms 410 and 420 is a cap reset phase represented between timing lines at 440. Lowering the voltage of the amplifier during cap reset at 440 allows for the switch that resets the high voltage MOM cap described above to not utilize a level shifter, further saving power. The next phase is a slewing up phase 450 to restore the amplifier output to the voltage utilized by the MEMS when switch (C) will be connected. The next phase for waveforms 410 and 420 is a drive phase represented between timing lines at 460. A method depicted in FIG. 5 will illustrate an example for generating the waveforms 410 and 420. The phases are typically controlled in timing by digital circuitry and can be controlled in firmware for various purposes, for example adjusting the timing of phases to the particular waveform including adjusting timing and/or voltages, for example.

In view of the foregoing structural and functional features described above, an example method will be better appreciated with reference to FIG. 5. While, for purposes of simplicity of explanation, the method is shown and described as executing serially, it is to be understood and appreciated that the method is not limited by the illustrated order, as parts of the method could occur in different orders and/or concurrently from that shown and described herein.

FIG. 5 illustrates an example method 500 for generating the print nozzle drive waveforms depicted in FIG. 4. At 510 of the method 500, a power up phase is performed. In this first phase, the operational amplifier described above is powered up, coming to a state where it can start to force its output near ground. At 520 of the method 500, a capacitor reset phase is performed. In this phase, the output of the operational amplifier is held near ground while the capacitors are essentially shorted. The amplifier can be disconnected from the print nozzle (e.g., micro-electromechanical system (MEMS) implementing print nozzle)) by a switch, and where the nozzle retains its voltage value through held charge. At 530 of the method 500, a drive phase is executed. In this phase, the capacitor reset switches are released, and the output of the operational amplifier is raised to the rest voltage of the nozzle (or MEMS device), the switch between the amplifier and the nozzle is closed, and then the nozzle drive pulse is applied, using the feedback of the capacitor pair of the capacitive network described above. At 540 of the method 500, a power off phase is performed. After the nozzle drive pulse is applied, the switch (e.g., switch 340 of FIG. 3) between the operational amplifier and the nozzle is opened, and then power is removed from the amplifier.

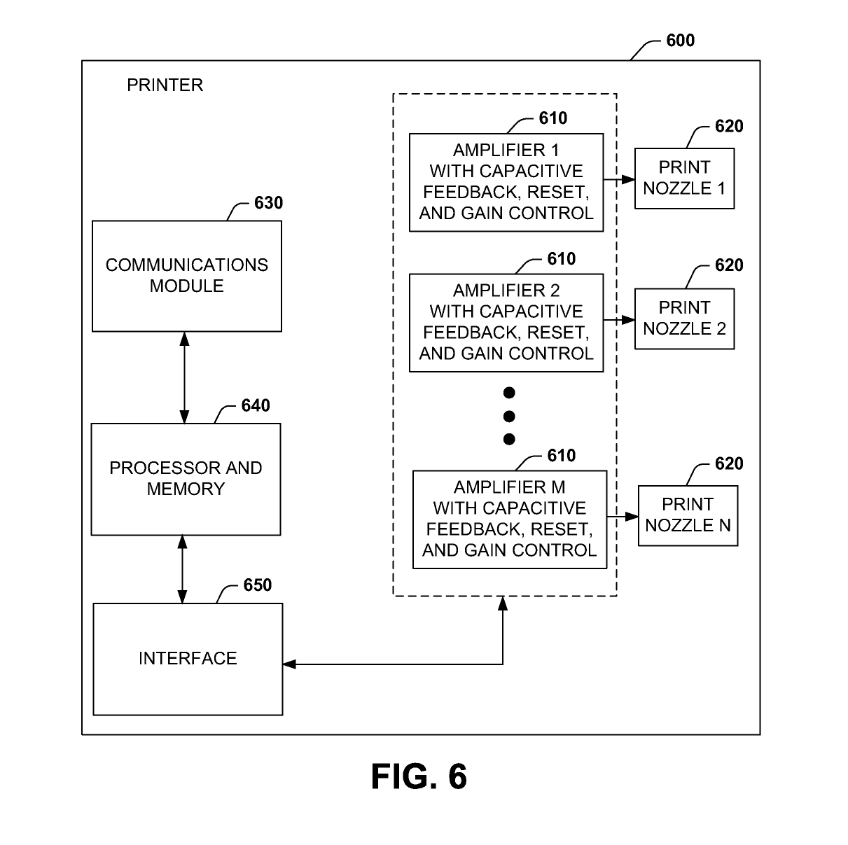

FIG. 6 illustrates an example printer 600 that employs amplifiers 610 utilizing capacitive feedback, reset controls, and gain controls to drive a plurality of print nozzles 620. The print nozzles 620 are shown as nozzles 1 through N, with N representing a positive integer. The respective print nozzles 620 are driven from a corresponding amplifier 610 shown as amplifiers 1 though M, with M representing a positive integer. Each of the respective amplifiers 610 employ continuous time capacitive feedback, reset controls, and gain controls as previously described. The amplifiers 610 and print nozzles 620 can be integrated on a common print head assembly, in one example, or implemented separately from each other in another example. The printer 600 can also include a communications module 630 for receiving print commands and updating printer status. The communications module 630 can include local connections such as from a print cable and/or can include remote network connections such as can be received from a local network and/or over a public network such as the Internet, for example. The communications module 630 can be operated by a processor and memory module 640 which can include executable operating instructions to operate the printer 600. Such instructions can operate the method 500 described above with respect to FIG. 5, for example, to generate drive waveforms at the print nozzles 620 and control reset operations in the amplifiers 610. The processor and memory module 640 can also connect to an interface module 650 that performs digital to analog conversions among other interface operations to control the amplifiers 610.

In another example, the method 500 can include powering an operational amplifier that utilizes a capacitive feedback network to drive a print nozzle at 510. The method 500 includes resetting voltages on capacitors inside the capacitive feedback network by closing switches that discharge voltages across the capacitors at 520. The method 500 includes executing a print nozzle drive phase via the operational amplifiers after the voltages on the capacitors are reset at 530. This includes disconnecting the operational amplifier from the print nozzle after executing the print nozzle drive phase at 540. The method 500 can also include multiplexing capacitors into the capacitive network to account for process variations in the capacitive network.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. An apparatus, comprising:
an operational amplifier to drive a print nozzle;
a continuous time capacitive network employed as feedback by the operational amplifier; and
a reset control to adjust startup voltages in the continuous time capacitive network.

2. The apparatus of claim 1, further comprising a gain control that is applied to the continuous time capacitive network to account for process variations in the continuous time capacitive network.

3. The apparatus of claim 2, wherein the gain control is a digital to analog converter (DAC) that selects a multiplexor to select a desired capacitance value inside the continuous time capacitive network.

4. The apparatus of claim 1, further comprising a digital to analog converter (DAC) to convert a digital print command to an analog voltage employed by the operational amplifier to drive the print nozzle.

5. The apparatus of claim 4, wherein the apparatus implements the print nozzle as a micro-electromechanical system (MEMS).

6. The apparatus of claim 1, wherein the reset control comprises a switch that is selectively closed to discharge a voltage across a capacitor in the continuous time capacitive network.

7. The apparatus of claim 6, wherein the capacitive network employs a high voltage capacitor to feedback voltages from the print nozzle to the operational amplifier.

8. The apparatus of claim 1, further comprising a switch to disconnect the output of the operational amplifier from the print nozzle during a power off phase.

9. A printer, comprising:
a plurality of print nozzles;
a plurality of operational amplifiers to drive the print nozzles, wherein the plurality of operational amplifiers have reset controls to adjust capacitive feedback networks in the plurality of operational amplifiers; and
a processor and memory module to direct remote print commands to the operational amplifiers to cause ink to be dispensed from the print nozzles.

10. The printer of claim 9, wherein the processor and memory module controls reset operations inside the capacitive feedback networks.

11. The printer of claim 9, wherein the plurality of print nozzles and the plurality of operational amplifiers are integrated on a common print head assembly.

12. The printer of claim 9, wherein each of the plurality of operational amplifiers further comprise a gain control that is applied to the capacitive feedback networks to account for process variations in the capacitive feedback network.

13. The printer of claim 12, wherein the gain control is a digital to analog converter (DAC) that selects a multiplexor to select a desired capacitance value inside the capacitive feedback networks.

14. A method, comprising:
powering an operational amplifier that utilizes a capacitive feedback network to drive a print nozzle;
resetting voltages on capacitors inside the capacitive feedback network by closing switches that discharge voltages across the capacitors;
executing a print nozzle drive phase via the operational amplifiers after the voltages on the capacitors are reset; and
disconnecting the operational amplifier from the print nozzle after executing the print nozzle drive phase.

15. The method of claim 15, further comprising multiplexing capacitors into the capacitive network to account for process variations in the capacitive network.
